(19) United States
(12) Patent Application Publication
(10) Pub. No.: US 2002/0067735 A1
(43) Pub. Date: Jun. 6, 2002

(54) Telecommunication system for control of multiple switches in a common address space

(76) Inventors: Johan Erik Lindstrom, Hagersten (SE); Eva Kristina Gorhammar, Molnbo (SE); Torgny Anders Lindberg, Tullinge (SE)

Correspondence Address: BURNS DOANE SWECKER & MATHIS L L P, POST OFFICE BOX 1404, ALEXANDRIA, VA, 22313-1404, US

(21) Appl. No.: 09/734,015

(22) Filed: Dec. 12, 2000

(30) Foreign Application Priority Data
Dec. 13, 1999 (SE) 9904553-6

(51) Int. Cl. H04L 12/56

(52) U.S. Cl. 370/422; 370/380

(57) ABSTRACT

A telecommunication system comprising an existing node with at least an existing switch with physical inlets and a local address space for addressing said physical inlets. At least one additional switch is added to the system, one of said additional switches residing in node that is external to the existing node. The additional switch or switches in the external node have also physical inlets and a local address space or spaces for addressing its switch inlets. A global address space is created which comprises at least the local address spaces of the existing switch and said one additional switch in the external node. The existing node has a connection handler for controlling the existing switch in the existing node and said one additional switch in the external node using the global address space (FIG. 2).

This invention relates generally to telecommunication system with nodes in which there are switches. In particular the invention relates to a telecommunication system of this kind wherein there is one node that controls its own switches as well as switches in other nodes.

The invention is of particular interest when there is an existing telecommunication system that needs to be expanded by adding new switches to the existing system. The added switches may be of other kinds (STM, ATM, IP) than those used in the existing telecommunication system. To expand an existing telecommunication system in this manner is a formidable task, requiring redesign of a large part of the software running in the existing telecommunication system. An object of the present invention is to allow the addition and control of new switches in new nodes to an existing telecommunication system only minor redesign of the existing software in the telecommunication system to which new switches in new nodes are added and controlled. By re-use of existing software the development costs are reduced. In particular the traffic control functions of the existing telecommunication system shall be re-used, that is shall remain unaffected by the addition of the new switches in the new nodes. However, the existing software for control of connections has to be redesigned. This object is achieved with the means indicated in the enclosed independent claims.

For example in a public telephone network using STM switches the switches that are added to the telephone network may be ATM switches of IP based switches that form a part of a data network. The STM switches have software for call control and call services, the added ATM switches or IP based switches have not. ATM switches are used for data traffic and do not have functions for call control and call services. In accordance with the invention the traffic control functions used in the telephony network are used also for call control of the added ATM switches. This with minor redesign of the software of the STM switches and the ATM switches. In accordance with the invention this is made possible by hiding the added switches so they cannot be seen by the traffic control system in STM switches. A connection handler in accordance with the invention will provide the hiding of the added switches. The added new switches are addressed by the traffic control functions in the same manner as the switches in the existing telecommunication system are addressed. In the existing telecommunication system a switch is controlled by addressing its multiple points, MUPs. In accordance with the invention the added new switches are controlled by addressing virtual MUPs, vMUPs. These belong to a global address space. To the system functions it does not matter if MUPs or vMUPs are addressed, they all look the same to the traffic system. In fact all switches, those already existing as well as whose which have been added, look like one big switch to the traffic control system. The traffic system functions “think” they operate on MUPs in the existing telecommunication system, while in reality they are operating on vMUPs which belong to new added switches. The global address space comprises the vMUPs of the added switches as well as the MUPs of the switches of the existing telecommunication system.

As is well known a main task of a connection handler is to set up point-to-point connections. The connection handler in accordance with the invention is added to the traffic control system and hides the added switches for the traffic control functions by translating the global addresses, MUPS as well as vMUPs, into local addresses, MUPs, for the individual switches. If an added switch does not have MUPs but for instance has channels or other logical representations, then a vMUP will address a channel or other logical representation in the respective switch. To summarize: the traffic control uses addresses in the global address space, and the connection handler translates the global addresses into local addresses and operates on the physical inlets of the individual switch.

The connection handler in accordance with the invention is similar to a conventional connection handler that operates on a single switch. However, the functionality connection handler in accordance with the invention is enlarged with functions for selecting the switch or switches to operate and functions for operating (set up, monitor and release) inter-switch connections.

As is well known a main task of a call handler is to identify the origin of a call (the caller) and to perform digit analysis in order to establish the destination of the call (the called party). Another task is to identify whether the call is a conventional two party call or if it is a multiparty call. A call handler in accordance with the present invention is similar to a conventional call handler. The call handler in accordance with the invention addresses all of the switches, existing as well as added ones, with the global address space. As mentioned above the global addresses are translated into switch identity and local addresses in the identified switch. The local addresses refer to physical inlets or other logical representation in the identified switch.

The size of the global address space is given by the size of the maximum pointer allowed by the traffic control system and is not depending on the size of switches. Typically the maximum size of a pointer is in the order of about 32 bits, that is 2³² addresses depending on the processors used, while a typical switch has 64 k or 128 k inlets which need to be addressed. Therefore there is plenty of room available for global addresses in the system.

In the preferred embodiment of the invention the lower part of the global address space is reserved for the existing switch in the controlling node. This is done for compatibility reasons, since certain MUP users, hardware entities as well as software entities, handled by the traffic control system cannot address addresses larger than 64 k or 128 k. These users require that the addresses used in the global address space are the same as the addresses they used in the old address space in the existing system, before switches were added. In the reserved part of the global address space a group switch MUP, GSMUP, has the same value as its corresponding vMUP. Because the values are the same, the connection handler will perform no translation from vMUP to local MUP for the addresses in the reserved portion. The size of the reserved portion is set either to 64 k or 128 k depending on the size of the existing switch.

Above the reserved portion of the global address space the global addresses are allocated one by one or in groups. Typically a group would comprise 32 addresses corresponding to 32 channels of a PCM trunk. In the U.S. a group would typically have 24 addresses; this number corresponding to the number of channels in a T1 system. Preferably the addresses of a group are allocated in a consecutive order.

There are two allocation processes. The first one takes place when hardware is connected to the group switch. Each hardware inlet is allocated a respective MUP. The MUP so allocated is herein referred to as a local MUP or local address. The second allocation process takes place when an additional switch is added to the existing system and comprises two steps. In the first step the global address space is generated and the lower part thereof is reserved. The MUPs of the existing switch are allocated a respective global address. For example the MUP that has the local address . . . 00001 is allocated the global address . . . 00001, the one with local address . . . 00010 is allocated global address . . . 00010 etc. until all of the MUPS have been given a respective global address. In the second step the local addresses of the physical inlets of the added switches are allocated global addresses above the reserved portion one by one or group wise.

Accordingly the call handler will have the same addressing space as before but it will not be addressing MUPs of a group switch, instead it will be addressing global MUPs. The call handler will, however, not recognise this. To the call handler all of the switches, existing as well as added, will be treated as were they just one big addressable switch. Internally in the connection handler a global address is translated into a MUP, a channel or whatever is the representation of its physical inlet.

### Related Technique

U.S. Pat. No. 5,960,004 in the name of Ramström et. al. is example of a software architecture that requires redesign of all of the existing software in the existing telecommunication system in which the new software is used. The development costs for the new software are accordingly high. The new software call model uses logical switch views in order to set up and release connections through a telecommunication system. The use of switch views to set up or release a connection requires much processor capacity. Once the new software has been loaded into the system the software will allow for expansion of the telecommunication system with new switches in new nodes.

In accordance with the invention a connection through the expanded telecommunication system is set up, released and manipulated stating the global addresses of the switches. The connection handler sets up, releases, and manipulates connections through the switches and between the switches. This new way of controlling the connections requires less processor capacity in comparison with said U.S. patent to Ramstrom. In accordance with the present invention the inlets of the switches are addressed which is in contrast to the Ramstrom approach wherein the connection is addressed. The Ramstrom patent has a great flexibility. Such flexibility is not required by the present invention. Therefore the solution of the present invention is not as capacity demanding as Ramstrom.

In order to fully understand the claims, the description and the merits of the invention some expressions must be clarified and some characteristics of the invention must be made clear.

### Definitions

In switch technology it is not proper to say that a switch has an input side and an output side, since each side of a switch can receive as well as send away a call. Instead a switch is said to have a number of inlets. Each inlet has an input and an output. An inlet is a two-way entity. Between two inlets either a two-way or a one-way connection can be established. A two-way connection will be using the input and the output of an inlet, a one-way connection only one of these.

### Inventive Features

The telecommunications system of the present invention comprises two or more nodes. One node (referred to as an internal node or an existing node or a controlling node) controls one or more switches (also referred to as one or more added switches) that are resident in one or more other nodes. The other nodes are referred to as external nodes or media gateways.

The existing node can control the entire or only a part of the added switch or switches in an external node. An external node may have other traffic that is controlled by its own traffic control system, said other traffic is thus not controlled by the control node.

The bearer services used be the switches in the existing node may be of one type which is different from that used in an external node. The telecommunication system may thus comprise mixed types of bearer services, such as STM, ATM and IP.

All external nodes have a common format for the manner in which they present or publish themselves to the controlling node. As an example this format is the identity ID of the inlet group and the identify ID of the particular inlet in the identified group. In some switch systems an inlet group is referred to as a switch device and the particular inlet of the identified switch device is referred to as channel.

The existing node may comprise a group switch and a subscriber switch stage. This being the case the group switch is controlled by group switch multiple points (GS MUPS) and the subscriber switch stage is not controlled by global addresses but by control store positions.

A portion of the global address space is reserved for the local address space of the controlling node. The reserved portion starts at address 0 and ends at address X, X being a parameter the value of which depends on at least three motives that optionally may be used separately or in combination. One such motive is that the new software used for control of connections, this software being referred to as a connection handler, shall be backwards compatible with old users (such as old trunks) of the addresses in the local address space of the existing node. Such old users may not, depending on the particular case, be able to handle the large global address space proposed by the invention. The reserved portion is therefore made equal to the address space the old users are capable of handling. A second motive is to reduce processor capacity by using, in the reserved portion of the global address space, that same address values as those used in the local address space of the controlling node. In doing this there is no need to map from global addresses to local addresses, thus reducing execution capacity. A third motive is the following: If a node is enhanced in accordance with the present invention so as to be a controlling node and this enhance node is to control its own switch only, thus not any additional switches in any external nodes, then the portion reserved in the global address space is made equal to the local address space of the existing switch. This will save any mapping activities as well as reduce processor capacity.

It should be noted that in case there are no old users to consider, that is there is no need to provide back-compatibility, then X can be zero which means that no portion of the global address space is reserved.

The global address is a global multiple position. The global multiple position is translated into a physical multiple position for the existing switch, or is translated into a virtual multiple position for the external switch or switches. A virtual multiple position represents the local address in the local address space of the external switch or switches. The global addresses and their respective translations are stored in a table together with the identity of the respective. The table is created when the local addresses of the switch or switches in the existing node and the local addresses of the switches of the external node or nodes are allocated to the global addresses. is performed and wherein the information stored in the table is used by the connection handler when a connection should be set up.

### DESCRIPTION OF THE DRAWINGS

FIG. 1a Is an overall view of a telecommunication system that has a node in accordance with the invention,

FIG. 1b Is an overall view of the node of FIG. 1a enhanced in accordance with the invention to provide an expanded telecommunication system in accordance with the invention,

FIG. 2 is an overall view of the invention showing a controlling node controlling its own STM switch as well as an external ATM switch and an interconnection trunk, said entities together forming a telecommunication system in accordance with the present invention,

FIG. 3 is showing the hardware configuration of the controlling node in FIG. 2 as seen from access point of view,

FIG. 4 is showing the hardware configuration of the system of FIG. 2(?)

FIG. 5 is showing a layered structure of the telecommunication system in accordance with the invention,

FIG. 6 is showing how the connection handler controls the hardware interfaces

FIG. 7 is an overall view of the system of FIG. 2 wherein nine basic call cases have been illustrated,

FIG. 8 is a simplified view of the system shown in FIG. 2 wherein the nine basic call cases of FIG. 6 have been reduced to three, two of which are identical from connection layer point of view,

FIG. 9 illustrates the global address space, gMUP range, and how portions thereof (GSMUPs, vMUPs, GSMUPs, GSMUPs/vMUPs) are assigned to different switches (the ATM switch in MG, the group switch GS, another external switch in the telecommunication system of the present invention and, to the left the internal switch in the controlling node,

FIG. 10 is a illustrating a file having in its middle column the local address spaces of the switches of the present telecommunication system, in its left column the global addresses in the global address space, and in its right column the switch identities; this file being shown by the shaded portion, and this file showing the allocation of local addresses to global addresses and the switch IDs,

FIG. 11 is a view showing a call example wherein a call is set up between users GMUP1 and vMUP1 residing in switches belonging to two different nodes, the group switch GS in the controlling node and the ATM switch in the external controlled node, this Figure showing signalling between the indicated entities of the telecommunication system,

FIG. 12 is a similar view to FIG. 11 and illustrates the release of the call that was set up in FIG. 10,

FIG. 13 is a view similar to FIG. 11 and illustrates connection case 3 shown in FIG. 8, and

FIG. 14 is a view similar to FIG. 13 and illustrates how the call set up in FIG. 12 is released.

### DETAILED DESCRIPTION OF THE INVENTION

In the following detailed description a controlling node is the controlling node referred to in the claims, call handler is the call handler referred to in the claims and connection handler is the connection handler referred to in the claims. Media gateway (MG) is the external node or other node referred to in the claims.

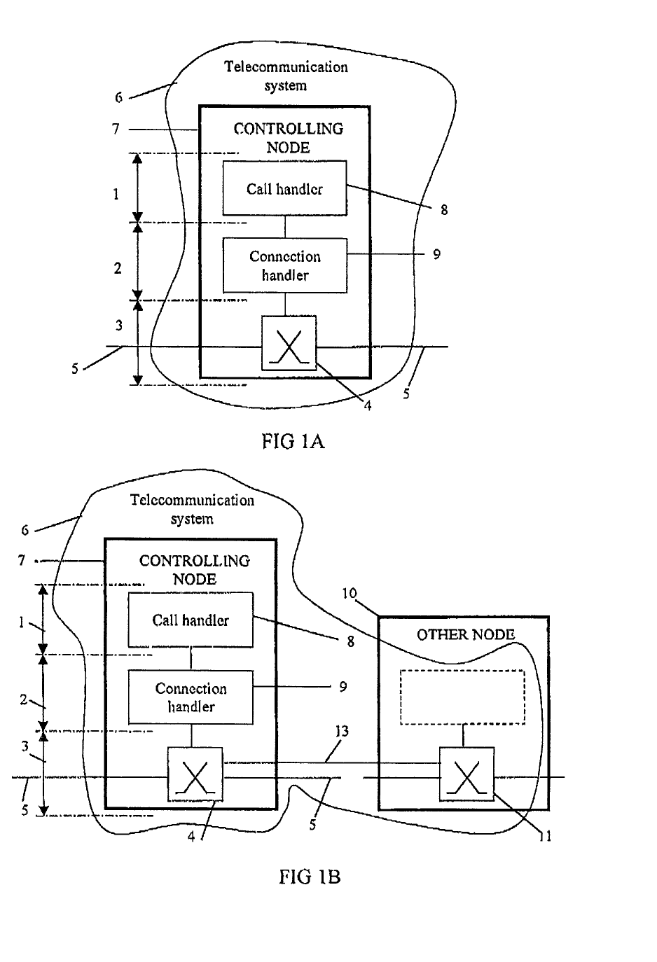

A telecommunication system shown in FIG. 1a can be described as consisting of three layers, a call handler layer 1, a connection handler layer 2, and a bearer service layer 3. In the bearer service layer switches 4 and other types of hardware (HW) will be found as well as HW drivers for this equipment. In the connection handler layer, there will be generic functions to relay requests for HW manipulation to the proper HW driver.

The call handler layer handles all the traffic control functions and decides what HW connections should be done based on information e.g. received via trunks 5.

Below is described how a node consisting of all these three layers can be further developed in the connection handler layer to control a multitude of switches, both in the own bearer service layer as well as in other nodes/machines, i.e. external switches, without affecting an existing call handler.

A node, referred to as a controlling node 6, in a telecommunication system 7 comprises a call handler 8, sometimes referred to as a traffic control system, and a connection handler 9.

The controlling node controls HW in another node 10. Said HW comprises one or more switches 11. If said other node 10 uses another transmission technique than that used in telecommunication system 7 then said controlled HW in said other node is referred to as a media gateway (MG) 12. Refer to FIG. 1b. In the embodiment described the system 7 is a STM system (synchronous transmission mode) while the other nod is part of an ATM system (asynchronous transmission mode).

The STM base controlling node has a wide variety of applications and an STM based connection handler. The ATM based other node supports only a limited set of services. The idea in system design is to use both nodes as one combined telecommunication system, using the switching capabilities of both switches 4 and 11, as well as application call services supported by the controlling node. The nodes 6 and 10 will not be integrated, they will rather be built as a “loosely coupled node”, so to make possible various independencies (separate projects, separate operation and maintenance systems (O&M systems), and independent development of systems. From a traffical point of view, the telecommunication system can be perceived as one transit node. By reusing STM HW in the controlling node, there will also be need for a speech carrying bearer between the controlling node and the MG12. This speech carrying bearer is an interconnect trunk, IT, 13.

This invention defines an evolution of the connection handler in the controlling node so it can control connections both in the controlling node and in the MG. The control will consist of e.g. setting up and releasing paths within the different switches, as well as controlling the interconnect trunk between the controlling node and the MG.

FIG. 1a, shows the existing telecommunication system 6 and FIG. 1b, shows how the telecommunication system will be expanded with new external switch(es) 11 which is controlled from the existing controlling node 7.

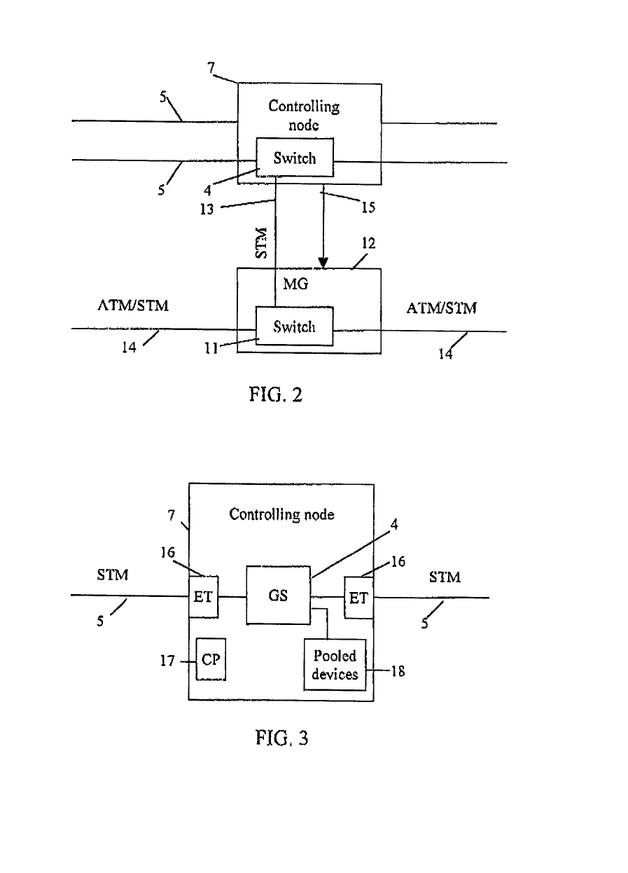

In FIG. 2 it is shown how the controlling node 7 is controlling (i) its own STM switch, (ii) an external ATM switch and (iii) the interconnect trunk 13.

Although the invention will be described with reference to an example wherein an STM system is extended to a combined STM/ATM system the invention is not limited to this but its principles can be used for introduction of new switches for any bearer types, based on a call control adapted to any other bearer services. STM and ATM are used purely as an example.

In FIG. 3, the basic HW modules in the controlling node before the new switch technology is shown. The controlling node 7 comprises the switch 4 and the trunks 5 connected thereto, the ATM switch 12 in the MG and trunks 14 connected to the ATM switch. The interconnection trunk 13 extends between switches 4 and 12. In the example shown the controlling node is designed to handle STM based traffic, the call handler in the call layer will order the connection handler to operate on the switches 1, 12 in the combined STM/ATM system.

The connection handler will send switching orders to the switch 4, which in the illustrated embodiment is a group switch 16, GS, so as to create paths between inlets of the GS. Over said paths is speech carried between two different multiple positions, MUPs, in the switch. If the call is going through several switches, for example switches 4 and 11, the call handler will send individual orders to all these switches. The switching order is sent over a control link 15. The connection handler in the controlling node will then address and control all these switches. The group switch is shown in more detail in FIG. 3 and comprises exchange terminals (ET) 16, a central processor (CP) 17 and pooled devices 18. An ET is an access device that handles time slots between a switch and a trunk connected to the switch. Pooled devices comprise different groups (pools) of devices. Examples of devices are tone senders, announcement machines, conference equipment, digit senders, and digit receivers.

### Group Switch Traffical Interface

Switch control for the GS and ATM switches is performed by the connection handler in the controlling node. When an application, for example a telephony application, wishes to manipulate a switch it should use only the specified user interface implemented by the connection handler.

The group switch provides a number of services to select, operate and release narrow-band paths in the group switch. The paths can be one-way, both-way or asymmetrical both-way connections. Asymmetrical is a one-way connection that can be changed into a both-way without seizure of new resources.

Examples of some typical basic traffical operations available towards the group switch are: select both-way path (secures HW resources), operate both-way path (along the connection), select and operate both-way path, release both-way path, convert path to asymmetrical, convert path to both-way, select one-way path, operate one-way path, select and operate one-way path, and release one-way path.

A path is a connection between two MUPs. A MUP can only receive speech from one other MUP. A MUP can send speech to several other MUPs.

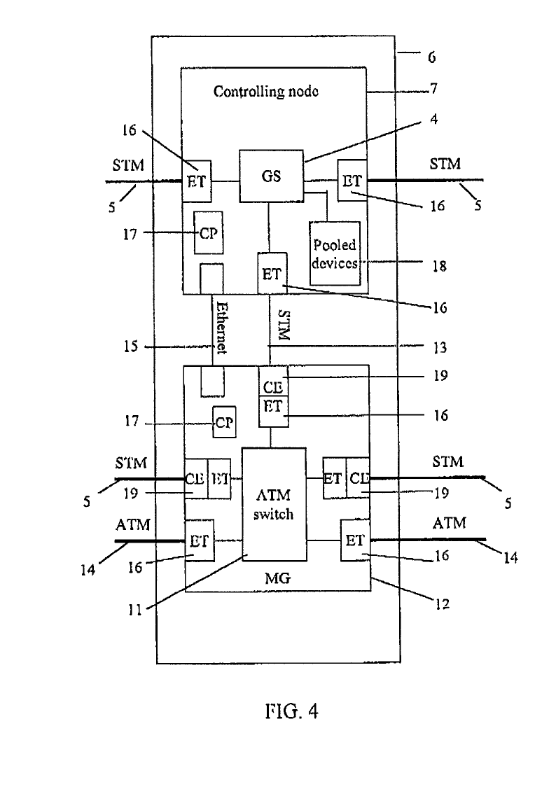

FIG. 4, shows the combined telecomsystem shown in FIG. 2 from HW and access point of view. Only relevant HW is shown. Circuit emulation devices CE 19 converts from STM to ATM allowing for STM access to the ATM switch. Control signalling between the call handler in the controlling node and a traffic control system 20 in MG takes place over Ethernet.

The controlling node's access device ET is of STM type (it could be either pulse code modulation PCM or 155 Mbit/s SDH). All ETs can send all standard tones used when trunks signal in transit applications to subscribers (BUSY tone, CONGESTION tone etc.). Voice and data connection between the MG and the controlling node, the interconnect trunk, should be done using 155 Mbit/s SDH.

The controlling node switch is a circuit switched 64 kbit/s switch, referred to as the group switch (GS). The GS can operate one-way or both-way connections between two multiple points, MUPs. The group switch is also capable to tap off (monitor) a setup connection to a third MUP. There can be several monitoring connections from one MUP. Each speech channel in an ET is connected to an MUP.

Any other special speech handling hardware like message sender, DTMF receiver, tone sender, conference equipment etc. is connected as pooled devices to the group switch. These types of equipment are only available in the controlling node.

The controlling node has Ethernet hardware to carry the control link which will carry the orders sent from the controlling node to the MG.

The access in MG are ATM and STM as evidenced by trunks 5 and 14. The STM is implemented as circuit emulation in the ET/CE. The voice and data connection between MG and the controlling node, i.e. over the interconnect trunk 13, should be done using the ET/CE devices shown.

The switch in the MG is an ATM switch. This switch only supports one-way or both-way connections. No monitoring can be performed. Supported ATM coding is AAL1 only. The CE/ET devices will pack and unpack one 64 kbit/s channel into one AAL1 channel.

The control link 15 is based on TCP/IP/Ethernet. A non illustrated central processor in MG 11 has the necessary HW and protocol stacks.

The connection handler and the ETs in the controlling node will see the MG as its extension, while existing parts of the MG will not be very much aware of the presence of the controlling node.

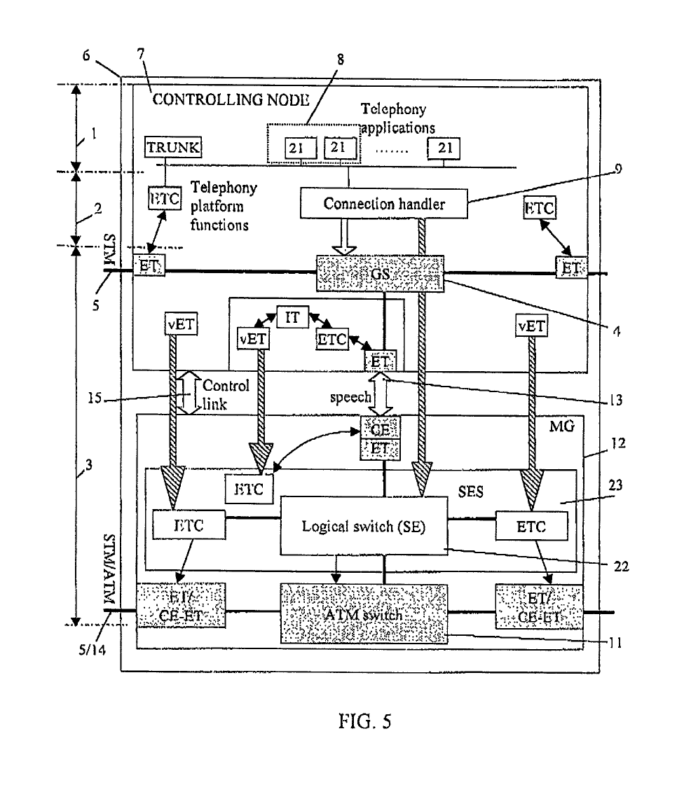

FIG. 5 illustrates the general software as well as hardware structure of the combined switch shown in FIG. 4. The general hardware general structure is shown with shaded rectangles.

The ATM switch, as perceived from telephony applications in the controlling node, will look like an extension of the group switch GS. Connection operations performed on the ATM switch have to be similar to those performed on the group switch GS so as not to make the connection handler too complicated. Access equipment, ETs and Ces, to the MG has to be seen as ordinary controlling node ETs for telephony applications in the controlling node.

A logical switch 22 is a software software implemented switch emulator (SE) included in a switch emulator subsystem (SES) 23 of the MG. A main task of SES 23 is to translate STM based control orders from the controlling node into ATM based control orders that are understood by the physical ATM switch. It communicates with the controlling node in “STM language” and with ATM switch in “ATM language”. The logical switch may be thought of as an STM switch interface towards the GS and it orders manipulation (set-up, release and supervision) of ATM-paths internally within the MG. As pointed out above the use of a logical switch will simplify the construction of connection handler in that it will always be operating in an STM environment regardless of the bearer service, be it STM, ATM, IP or whatever. Therefore the software used for call control in the existing node can be reused and is the same irrespective of whether it controls switches in its own node or switches in other nodes. Further said call control software is the same regardless of the bearer service used. The switch emulator sub system has several interfaces towards the controlling node and towards the ATM switch. The hardware realised ETs and CEs residing in MG will have their controlling functions, referred to as exchange terminal controllers ETCs, within the SES (MG). There are another virtual counterparts of the MG based Ets. Said virtual ETs are labeled vET and they reside in the controlling node. The SE will use channels within a switch device, SD; as the switching points (compare to MUP).

The trunks in the controlling node will perceive the vET as a local controlling node ET, and will not be aware of the absence of hardware realised ETs. The call handler will use the connection handler as usual to operate the switching equipment. The connection handler will use the logical switch in SES as a hardware-realised switch. In this way telephony applications in the controlling node will have full control over the MG connections both from access point of view and from call control point of view.

Some of the telephony applications together form the call handler.

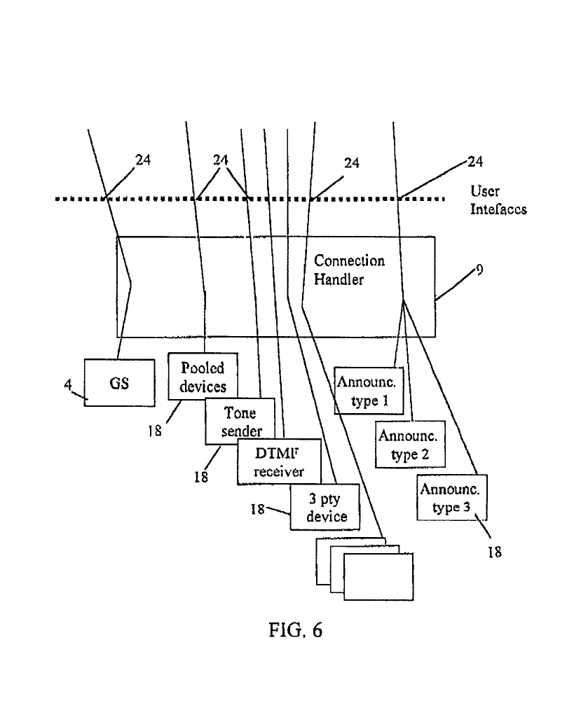

The interconnect trunk IT comprises of a number of STM narrowband channels. The channels are terminated in ET on the controlling node side and in CE on the MG side. It will occupy a range of MUPs on the controlling node side (GS) and also a range of channels grouped within switch devices on the MG side. Examples of switch devices are shown in FIG. 6 and comprise tone senders, tone receivers, 3-party devices (conference equipment), group switch.

There will be a fixed connection between the MUPS of the interconnect trunk and the SE channels of the interconnect trunk. A device owner, that is software and hardware entities operating a device, is designed to associate the correct SE-channel with the correct MUP. A device owner is referred to as the interconnect trunk IT. The IT is realised in the controlling node.

The connection handler coordinates the orders given from the different users via the GS and other user interfaces and orders setting up of a physical path in the switching equipment. Examples of user interfaces are collectively shown at 24 in FIG. 6. FIG. 6 shows how the connection handler controls HW interfaces.

The purpose of the connection handler is to receive orders according to the user interface and change them into orders to device drivers (3-party devices, group switch, etc.).

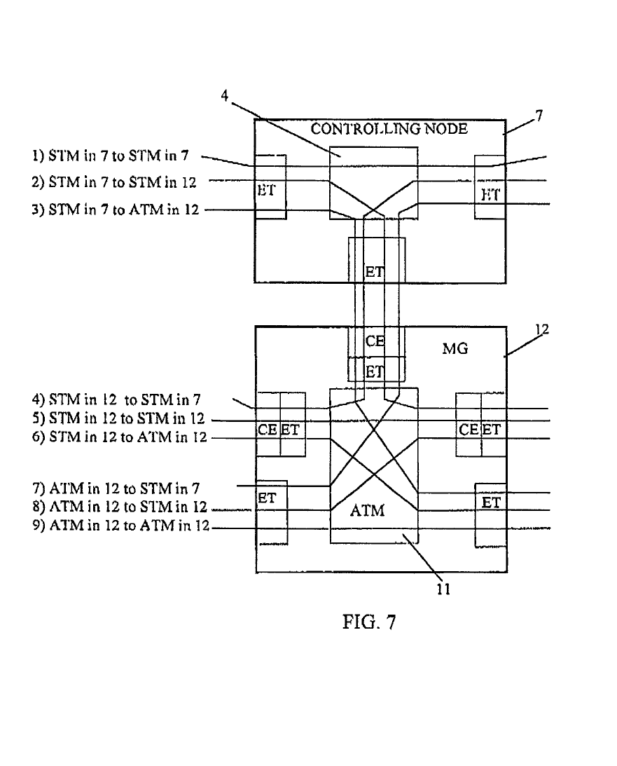

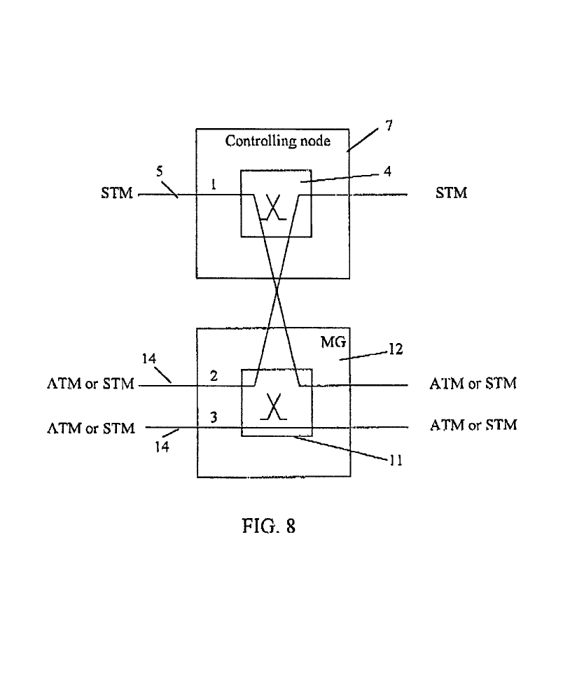

There are 9 basic call cases required for subscriber A to subscriber B calls. These are shown in FIG. 7. From the controlling node's connection control point of view, these basic traffic cases can be simplified. There are two assumptions:

Regarding the controlling node's connection control there is no difference between ATM and STM access to/from the MG.

The traffic case STM(controlling node)—STM(controlling node) will not be considered, as it is already implemented in the design base.

When taking the listed assumptions into consideration, the 9 basic traffic cases will reduce to 3 basic connection cases. See FIG. 8, where the connection cases are signed by numbers.

Furthermore connection cases 1 and 2 are equal from the controlling node's connection handler point of view. This is so because the connection handler does not distinguish between incoming and outgoing side of a call.

There are two main alternatives to implement the inventive telecommunication system described above. One is to adapt the existing implementation so that trunk blocks with accesses in MG will be using the switch view technique shown in U.S. Pat. No. 5,960,004 referred to above.

The other alternative is based on the fact that the traffical users of the controlling node's connection handler will see no difference in controlling the GS or the MG or any other switch external or internal irrespective of the bearer service which is used. Operations that are valid on the GS will be valid on the MG as well. The users will use the group switch user interface to control the MG.

Trunks will use MUPs in a conventional manner. A MUP will represent a resource either in the controlling node or in MG. A MUP will be used by the call handler in a conventional manner.

Connection control in basic calls should be done without use of the previously mentioned switch views. The call handler will set up the connections in conventional manner, which means that it will operate a path by using MUPs. MUPs that are used for addressing the controlling node and the MG resources have to be unique. This implies that the range of MUPs belonging to the MG must not overlap the MUP ranges that already exist within the controlling node.

In accordance with the invention a unique, global MUP (gMUP) range is created. Global MUPs will be seen by, that is are visible to, the controlling node GS users (call handler, ISUP/TUP protocols, call layer). GMUPs will be translated into physical MUPs for the group switch GS, and into virtual MUPs, vMUPs, for external added switches, when they are received by the respective switch, that is by the group switch or be an external switch.

A vMUP represents an inlet in an external switch and consists of switch identity and channel.

GMUPs 0 . . . X can be reserved for and associated with the corresponding physical MUPs (0 . . . X). X could, for example, be set to 64 k or to the maximum size of the group switch. X is an application parameter, i.e. a value which may depend on the market at which the invention is used.

The reasons why such a reservation is made are the following:

Old MUP owners and device owners might not support a group switch larger than 64 k. X must be set to at least 64 k, to avoid changes in the old users.

If X is set to the maximum size of the group switch GS, translation from gMUP to physical MUP is not necessary. It can be used for capacity reasons or to avoid changes in existing GS software, but also to avoid changes for devices which have already connected HW, when this function is added to an existing live controlling node.

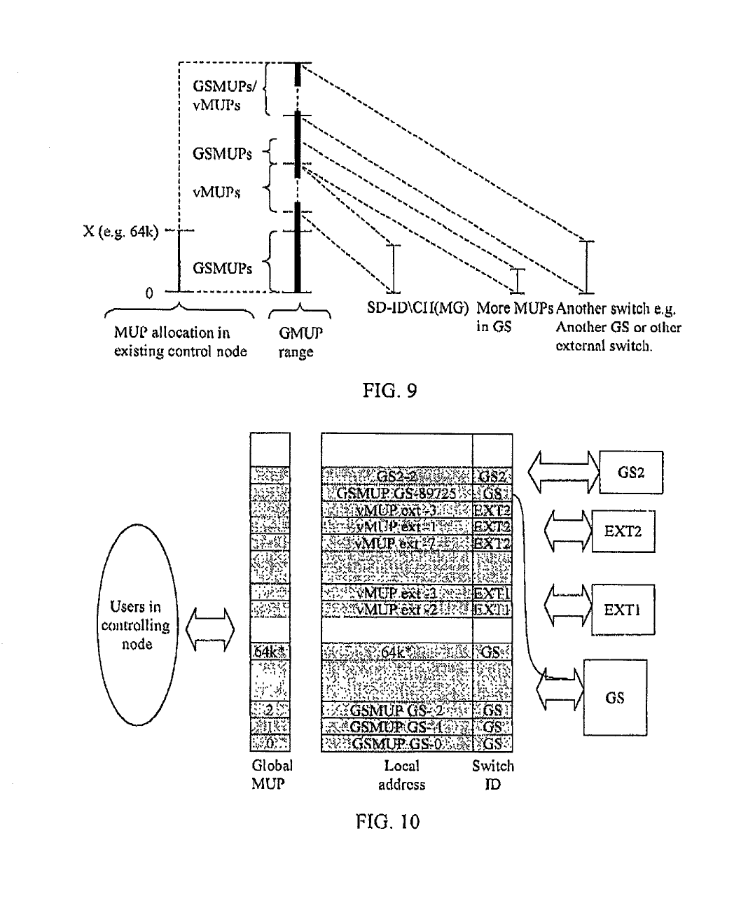

FIG. 9 shows the above concept. It also shows how the concept is open for unknown future switching systems to be controlled by the controlling node.

To make possible a translation between gMUP and “local MUP/switch reference” a gMUP file is created. The pointer will correspond to a gMUP value. Each record of the gMUP file will contain the local MUP (either physical MUP, or virtual MUP) and a reference (switch ID) to the switch to which the local MUP belongs.

In FIG. 10 the gMUP translation table is shown. The local MUP values, GS-MUPs or virtual MUPs, will be tolerated to gMUPs when operation and maintenance procedures (O&M procedures) are run in order to define new hardware that are added to the telecommunication system. The O&M system will ask the connection handler for gMUP interval. So, MG data is given to the connection handler by administrative procedures.

The GMUP file size indirectly depends on the size of different switches.

The global MUPS are allocated one by one or in a group. If they are allocated by group they are allocated in consecutive order for consecutive physical or virtual MUPs, i.e. the range of global MUPs has no holes. For example the group switch MUPs 75040-75071 will be given the global MUPs 123110-123141.

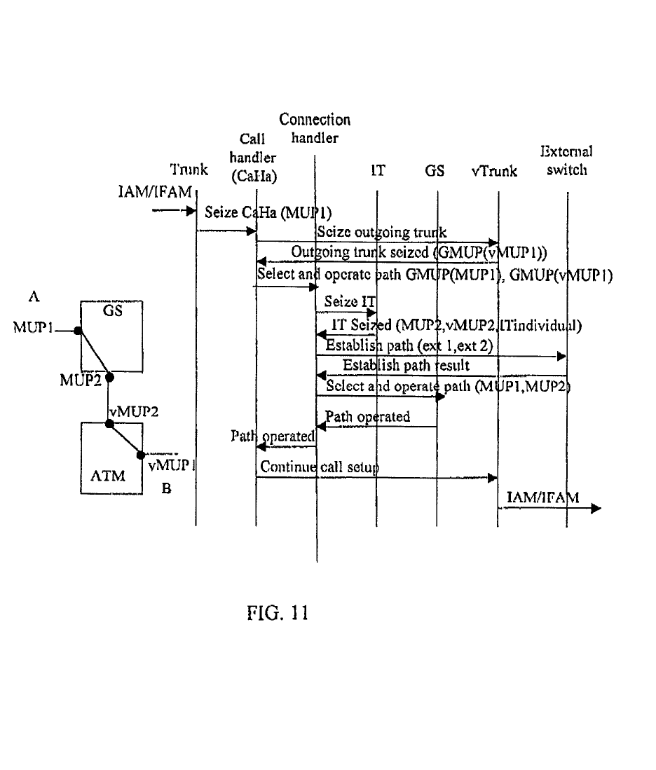

The controlling node users (trunks, call handler) will see only gMUPs. When, for example, the call handler wants to operate a path, the MUPs sent by the call handler and received by the connection handler will be translated into local MUPs plus references. Further, the connection handler will establish the path through the group switch and/or external switch and, if applicable, also over the interconnect trunk, IT. A typical set up of a path from a subscriber A to a subscriber B through the controlling node and the MG is described below with reference to FIG. 11 which illustrates connection case 1. An initial address message (IAM/IFAM message) is received by an ISUP/TUP part in the call handler. The MUP on which this message is received is known to the trunk. This MUP is labelled MUP1. Next the trunk seized the call handler with the GMUP for MUP1. Next the call handler performs digit analyses of the B-number. Since the B-number does not belong to a subscriber connected to the GS, an outgoing trunk, which leads to the B-number, is selected by the call handler. This outgoing trunk is seized. One data item received by the call handler in response to the seizure of the trunk is the vMUP1 to which user B belongs. Next the call handler starts to set up a path between MUP1, which corresponds to user A, and vMUP1, which corresponds to user B. The call handler sends an order to select and operate path GMUP(MUP1); GMUP(vMUP1) to the connection handler. The connection handler must now analyse if these GMUPS belong to the same switch or not. Since they do not belong to one and the same switch a path must be set up between the involved switches. The connection handler therefore next seizes the interconnect trunk. In response to this seizure the connection handler receives two MUPs, in this case GMUP(MUP2) and GMUP(vMUP2). Also the individual identity of the seized interconnect trunk is received. Now the connection handler has knowledge of the four switch positions. The path through the interconnect trunk is already established and what still needs to be done is to set up the two paths through the two switches. Next the connection handler sends an order, “Establish path (EXT1, EXT2)” to the ATM switch (rather to the logical switch (SE)) requesting it establish the MG part of the path. In response to this the connection handler receives the result, “path established”, of request. Next the connection handler sends an order “select and operate path MUP1; MUP2” to the GS. That is the controlling node part of the path. In response to this the connection handler receives the result, “path established”, of request. This completes the path between subscriber A and subscriber B.

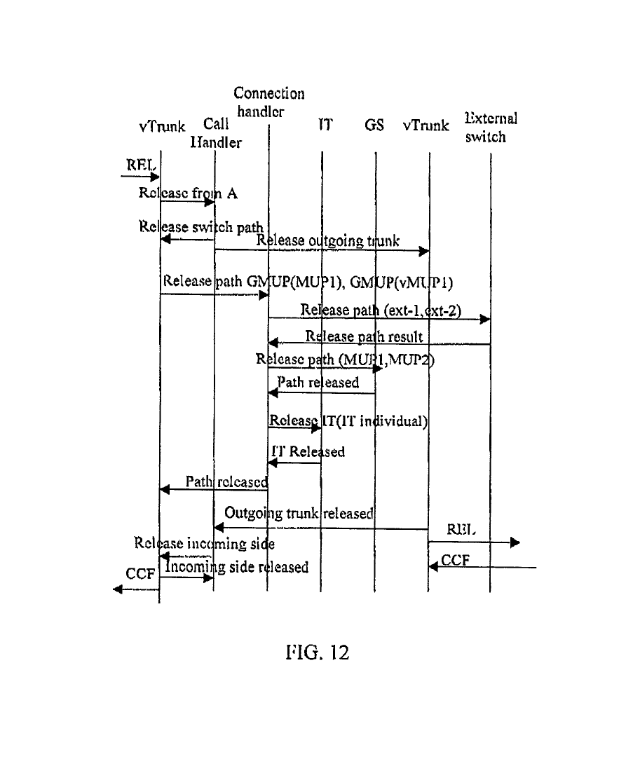

Release from the A subscriber side of the above described set up connection from A side is shown in FIG. 12. When the call handler has received a release order, it orders release of the switch path towards the incoming side. At the same time the call handler releases the outgoing side. The connection handler receives an order “release_bothway_path” from incoming side and releases the switch path.

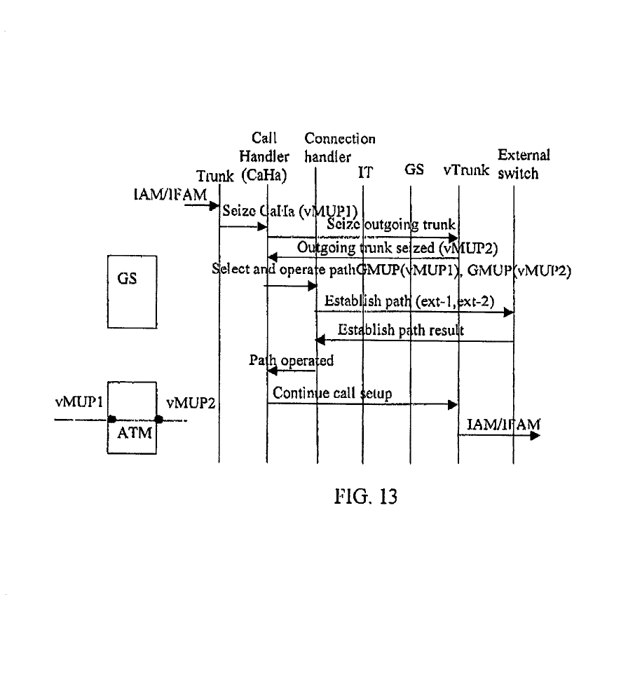

A typical call through the MG will next be described with reference to FIG. 13 which illustrates connection case 3. After an IAM/IFAM message has been received by a route that belongs to a virtual trunks, the route seizes the call handler with the GMUP for vMUP1. As the call handler analysis points to an outgoing route that belongs to an outgoing virtual trunk, the call handler seizes the virtual trunk and gets the GMUP for vMUP2 from it. An order to select and operate path is sent to the connection handler. The connection handler sends an order to the logical switch SE requesting it to establish the path.

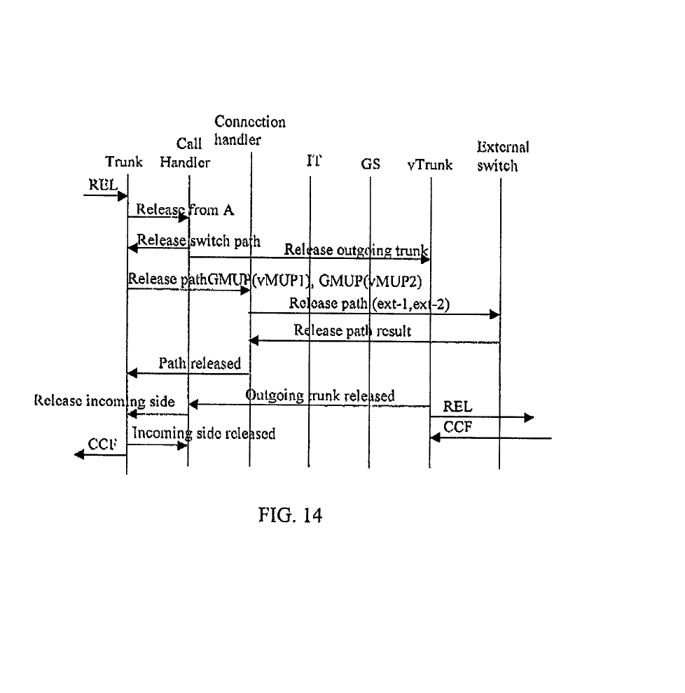

Release from the A side (subscriber A) is shown in FIG. 14. When the call handler has received a release order, it orders release of the switch path towards the incoming side. At the same time the call handler releases the outgoing side. The connection handler receives an order “Release path GMUP(vMUP1), GMUP(vMUP2)” from the incoming side and releases the switch path.

Abbreviations and Definitions

| | |
|---|---|
| ASV | Access Switch View |
| ATM | Asynchronous Transfer Mode |
| CE | Circuit Emulation |
| CH | Channel |
| CS | Combined Switch |
| COS | Connection Service Subsystem |
| DTMF | Dual Tone Multi-Frequency (Signalling) |
| DR | Digit Receiver |
| EC | Echo Canceller |
| ET | Exchange Terminal |
| ETC | ET Controller |
| gMUP | Global MUP |
| GS | Group Switch |
| GSH | GS Handler |
| HW | Hardware |
| IAM | Initial Address Message |
| IFAM | Initial and Final Address Message (TUP message) |
| IN | Intelligent Network |
| ISDN | Integrated Services Digital Network |
| ISUP | ISDN User Part |
| IT | Interconnect Trunk |
| MG | Media Gateway, |
| MS | Message Sender |
| MUP | Multiple Position |
| O&M | Operation and Maintenance |
| PCM | Pulse Code Modulation |
| SCP | Switch Control Protocol |
| SD | Switch Device |
| SDH | Synchronous Digital Hierarchy |
| SDId | Switch Device Identity |
| SE | Switch Emulator |
| SES | Controlling node Logical switch Subsystem |
| STM | Synchronous Transfer Mode |
| SW | SoftWare |
| TC | Traffic Control |
| TS | Tone Sender, Time Switch |
| TUP | Telephony User Part |
| vET | Virtual Exchange Terminal |
| vMUP | Virtual MUP |

1. A telecommunication system comprising an existing node with at least an existing switch with physical inlets and a local address space for addressing said inlets, wherein at least one additional switch is added to the telecommunication system, at least one of said additional switches residing in a node external to the existing node, each of said additional switches having physical inlets and a local address space for addressing said inlets, and in the existing node creating
(a) a global address space comprising the local address spaces of all the switches
(b) and means for controlling all said switches using the global address space,
thus changing the existing node to a controlling node.

2. A telecommunication system in accordance with claim 1, wherein the controlling node controls the entire additional switch in an external node or a part of the additional switch.

3. A telecommunication system in accordance with claim 2, wherein the local address space for the additional switch in the external node comprises as many addresses as the number of inlets controlled by the controlling node.

4. A telecommunication system in accordance with claim 3, wherein an address in the global address space is mapped to an address in the local address space of a switch and the identity of the switch

5. A telecommunication system in accordance with claim 4, wherein a connection handler in said controlling node performs said mapping.

6. A telecommunication system in accordance with claim 5, wherein the global addresses have the same format as the local addresses of the existing switch.

7. A telecommunication system in accordance with claim 6, wherein the format of the local addresses of said switches being the same as or different from the format of the global addresses.

8. A telecommunication system in accordance with claim 7, wherein the format of the local addresses for an additional switch in an external node expresses a group of inlets and the individual inlet in said group.

9. A telecommunication system in accordance with claim 8, wherein said format expresses switch device and switch device channel.

10. A telecommunication system in accordance with claim 9, wherein there are more than one external node each having at least one additional switch controlled by the controlling node, wherein said format is common to all external nodes.

11. A telecommunication system in accordance with claim 10, wherein the local addresses of said switches are allocated one by one to global addresses in a 1:1 relationship, or said local addresses of said switches are allocated in groups to groups of global addresses, the local as well as global addresses of a group being in consecutive order.

12. A telecommunication system in accordance with claim 11, wherein said allocation is made in the connection handler.

13. A telecommunication system in accordance with claim 12, wherein all said switches are addressed by their global addresses so as to appear as one single switch to a call handler in the controlling node.

14. A telecommunication system in accordance with claim 13, wherein said call handler is using two addresses in the global address space in order to set up, release, and manipulate a connection through the telecommunication system regardless of to which switch or switches the two global addresses are allocated.

15. A telecommunication system in accordance with claim 14, wherein said call handler is using the same interface to set up, release, and manipulate a connection through the telecommunication system as the call handler previously used to set up, release, and manipulate connections in the existing switch.

16. A telecommunication system in accordance with claim 14, wherein interswitch connections are independently set up by the connection handler in response to said call handler requesting a connection be set up between two global addresses in different switches.

17. A telecommunication system in accordance with claim 16, wherein the connection handler seizes an interconnection trunk, the interconnection trunk in response thereto returning two global addresses, one belonging to one of the switches and the other belonging to the other switch, the connection handler in response to reception of the two global addresses setting up a connection in each of the two switches.

18. A telecommunication system in accordance with claim 12, wherein a predefined part of said global address space is reserved for the existing switch and the local addresses of the existing switch are the same as the global addresses, thus not requiring any mapping in the reserved part.

19. A telecommunication system in accordance with claim 18, wherein said reserved part of the global address space starts at address 0.

20. A telecommunication system in accordance with claim 19, wherein the size of the reserved part is at least equal to the range of local addresses which software related to old trunks in the controlling node is capable of handling, thus providing backwards compatibility.

21. A telecommunication system in accordance with claim 20, wherein the size of the reserved part is at least equal to the maximum size of the existing switch, thus providing backwards compatibility for software related to the existing switch.

22. A telecommunication system in accordance with claim 20, wherein the size of the reserved part is at least equal to the maximum size of an enhanced existing switch with software capable of allocating global addresses, thus reducing execution time since no mapping is required.

23. A telecommunication system in accordance with claim 22, wherein said reserved part is less than the size of an enhanced existing switch, thus requiring allocation of global addresses for the local addresses above the reserved part.

24. A telecommunication system in accordance with claim 23, wherein when allocating a global address for a local address of the enhanced existing switch in the reserved part of the global address space the returned global address is the same as the local address, thus making the software doing the allocation independent of the size of the reserved part.

25. A telecommunication system in accordance with claim 1, wherein the size of the global address space is given by a control system in the controlling node.

26. A telecommunication system in accordance with claim 17, wherein the switches of the telecommunication system are of different kinds, thus providing a telecommunication system that comprises different kinds of switching technologies, where all switches are controlled by said controlling node.

27. A telecommunication system in accordance with claim 26, wherein the switches are selected from the group that consists of STM (synchronous transmission mode) based switches, ATM (asynchronous transmission mode) based switches and IP (Internet Protocol) based switches.

28. A telecommunication system in accordance with claim 27, wherein the existing switch is an STM-based switch and the additional switch in the external node is an ATM based switch.

29. A telecommunication system in accordance with claim 12, wherein the existing switch is a group switch.

30. A telecommunication system in accordance with claim 29, wherein a global address is a global multiple position, which is translated into a group switch multiple position for the existing switch, or into a virtual multiple position for an additional switch in an external node, said virtual multiple position representing the local address of the additional switch.

31. A telecommunication system in accordance with claim 17, wherein the global addresses and their respective translations are stored in a table.

32. A telecommunication system in accordance with claim 31, wherein said table is created in the connection handler when said allocation is performed and the information stored in the table is used by the connection handler when a connection is set up.

33. A telecommunication system comprising an existing node with at least an existing switch with physical inlets and a local address space for addressing said inlets, said existing node having a layered structure comprising a bearer service layer with said existing switch and other hardware entities, a connection layer with generic functions for controlling the switch and the hardware entities, and a call layer with traffic control functions and functions for deciding the connections to be made, wherein at least one additional switch is added to the telecommunication system, at least one of said additional switches residing in a node external to the existing node, each of said additional switches having physical inlets and a local address space for addressing said inlets, and in the existing node creating
(a) a global address space comprising the local address spaces of all the switches
(b) and means for controlling all said switches using the global address space,
which is used by the call layer.

34. A telecommunication system in accordance with claim 33, wherein the controlling node controls the entire additional switch in an external node or a part of the additional switch.

35. A telecommunication system in accordance with claim 34, wherein the local address space of the additional switch in the external node comprises as many addresses as the number of inlets controlled by the controlling node.

36. A telecommunication system in accordance with claim 35, wherein an address in the global address space is mapped to an address in the local address space of a switch and the identity of the switch.

37. a telecommunication system in accordance with claim 36, wherein a connection handler in said controlling node performs said mapping.

38. A telecommunication system in accordance with claim 37, wherein the global addresses have the same format as the local addresses of the existing switch.

39. A telecommunication system in accordance with claim 38, wherein the format of the local addresses of said additional switches being the same as or different from the format of the global addresses.

40. A telecommunication system in accordance with claim 39, wherein the format of the local addresses for an additional switch in an external node expresses a group of inlets and the individual inlet in said group.

41. A telecommunication system in accordance with claim 40, wherein said format expresses switch device and switch device channel.

42. A telecommunication system in accordance with claim 41, wherein there are more than one external node each having at least one additional switch controlled by the controlling node, wherein said format is common to all external nodes.

43. A telecommunication system in accordance with claim 42, wherein the local addresses of said switches are allocated one by one to global addresses in a 1:1 relationship, or said local addresses of said switches are allocated in groups to groups of global addresses, the local as well as global addresses of a group being in consecutive order.

44. A telecommunication system in accordance with claim 43, wherein said allocation is made in the connection handler.

45. A telecommunication system in accordance with claim 44, wherein all said switches are addressed by their global addresses so as to appear as one single switch to a call handler in the controlling node.

46. A telecommunication system in accordance with claim 45, wherein said call handler is using two addresses in the global address space in order to set up, release, and manipulate a connection through the telecommunication system regardless of the which switch or switches the two global addresses are allocated.

47. A telecommunication system in accordance with claim 46, wherein said call handler is using the same interface to set up, release, and manipulate a connection through the telecommunication system as the call handler previously used to set up, release, and manipulate connections in the existing switch.

48. A telecommunication system in accordance with claim 46, wherein interswitch connections are independently set up by the connection handler in response to said call handler requesting a connection be set up between two global addresses in different switches.

49. A telecommunication system in accordance with claim 48, wherein the connection handler seizes an interconnection trunk, the interconnection trunk in response thereto returning two global addresses, one belonging to one of the switches and the other belonging to the other switch, the connection handler in response to reception of the two global addresses setting up a connection in each of the two switches.

50. A telecommunication system in accordance with claim 44, wherein a predefined part of said global address space is reserved for the existing switch and the local addresses of the existing switch are the same as the global addresses, thus not requiring any mapping in the reserved part.

51. A telecommunication system in accordance with claim 50, wherein said reserved part of the global address space starts at address 0.

52. A telecommunication system in accordance with claim 51, wherein the size of the reserved part is at least equal to the range of local addresses which software related to old trunks in the controlling node is capable of handling, thus providing backwards compatibility.

53. A telecommunication system in accordance with claim 52, wherein the size of the reserved part is at least equal to the maximum size of the existing switch, thus providing backwards compatibility for software related to the existing switch.

54. A telecommunication system in accordance with claim 52, wherein the size of the reserved part is at least equal to the maximum size of an enhanced existing switch with software capable of allocating global addresses, thus reducing execution time since no mapping is required.

55. A telecommunication system in accordance with claim 54, wherein said reserved part is less than the size of an enhanced existing switch, thus requiring allocation of global addresses for the local addresses above the reserved part.

56. A telecommunication system in accordance with claim 55, wherein when allocating a global address for a local address of the enhanced existing switch in the reserved part of the global space the returned global address is the same as the local address, thus making the software doing the allocation independent of the size of the reserved part.

57. A telecommunication system in accordance with claim 33, wherein the size of the global address space is given by a control system in the controlling node.

58. A telecommunication system in accordance with claim 49, wherein the switches of the telecommunication system are of different kinds, thus providing a telecommunication system that comprises different kinds of switching technologies, where all switches are controlled be said controlling node.

59. A telecommunication system in accordance with claim 58, wherein the switches are selected from the group that consists of STM (synchronous transmission mode) base switches, ATM (asynchronous transmission mode) based switches, and IP (Internet Protocol) based switches.

60. A telecommunication system in accordance with claim 59, wherein the switch in the controlling node is an STM-based switch and the additional switch in the external node is an ATM based switch.

61. A telecommunication system in accordance with claim 44, wherein the switch in the controlling node is a group switch.

62. A telecommunication system in accordance with claim 61, wherein a global address is a global multiple position, which is translated into a group switch multiple position for the existing switch, or into a virtual multiple position for an additional switch in an external node, said virtual multiple position representing the local address of the additional switch.

63. A telecommunication system in accordance with claim 49, wherein the global addresses and their respective translations are stored in a table.

64. A telecommunication system in accordance with claim 63, wherein said table is created in the connection handler when said allocation is performed and the information stored in the table is used be the connection handler when a connection is set up.

65. A telecommunication system comprising a controlling node with at least one switch and at least one other node with at least one other switch controlled by the controlling node, each of the switches having physical inlets and a local address space addressing said inlets, and in the controlling node (a) a global address space comprising all local address spaces and (b) means for controlling all switches using the global address space.

66. A telecommunication system in accordance with claim 65, wherein the controlling node controls the entire switch in an other node or a part of the switch in the other node.

67. A telecommunication system in accordance with claim 66, wherein the local address space of the switch in the other node comprises as many addresses as the number of inlets controlled by the controlling node.

68. A telecommunication system in accordance with claim 67, wherein an address in the global address space is mapped to an address in the local address space of a switch and the identity of the switch.

69. A telecommunication system in accordance with claim 68, wherein a connection handler in said controlling node performs said mapping.

70. A telecommunication system in accordance with claim 69, wherein the format of the local addresses of said other switches being the same as or different from the format of the global addresses.

71. A telecommunication system in accordance with claim 70, wherein the format of the local addresses for a switch in an other node expresses a group of inlets and the individual inlet in said group.

72. A telecommunication system in accordance with claim 71, wherein said format expresses switch device and switch device channel.

73. A telecommunication system in accordance with claim 72, wherein there are more than one other node each having at least one switch controlled by the controlling node, wherein said format is common to all of said other nodes.

74. A telecommunication system in accordance with claim 73, wherein the local addresses of said switches are allocated one by one to global addresses in a 1:1 relationship, or said local addresses of said switches are allocate in groups to groups of global addresses, the local as well as global addresses of a group being in consecutive order.

75. A telecommunication system in accordance with claim 74, wherein said allocation is made in the connection handler.

76. A telecommunication system in accordance with claim 75, wherein all said switches are addressed by their global addresses so as to appear as one single switch to a call handler in the controlling node.

77. A telecommunication system in accordance with claim 76, wherein said call handler is using two addresses in the global address space in order to set up, release, and manipulate a connection through the telecommunication system regardless of to which switch or switches the two global addresses are allocated.

78. A telecommunication system in accordance with claim 77, wherein interswitch connections are independently set up by the connection handler in response to said call handler requesting a connection be set up between two global addresses in different switches.

79. A telecommunication system in accordance with claim 78, wherein the connection handler seizes an interconnection trunk, the interconnection trunk in response thereto returning two global addresses, one belonging to one of the switches and the other belonging to the other switch, the connection handler in response to reception of the two global addresses setting up a connection in each of the two switches.

80. A telecommunication system in accordance with claim 75, wherein a predefined part of said global address space is reserved for the first switch in the controlling node and the local addresses of said first switch are the same as the global addresses, thus not requiring any mapping in the reserved part.

81. A telecommunication system in accordance with claim 80, wherein said reserved part of the global address space starts at address 0.

82. a telecommunication system in accordance with claim 81, wherein the size of the reserved part is at least equal to the maximum size of said first switch with software capable of allocating global addresses, thus reducing execution time since no mapping is required.

83. A telecommunication system in accordance with claim 82, wherein said reserved par is less than the size of said first switch, thus requiring allocation of global addresses for the local addresses above the reserved part.

84. A telecommunication system in accordance with claim 83. wherein when allocating a global address for a local address of said first switch in the reserved part of the global address space the returned global address is the same as the local address, thus making the software doing the allocation independent of the size of the reserved part.

85. A telecommunication system in accordance with claim 65, wherein the size of the global address space is given by a control system in the controlling node.

86. A telecommunication system in accordance with claim 79, wherein the switches of the telecommunication system are of different kinds, thus providing a telecommunication system that comprises different kinds of switching technologies, where all switches are controlled by said controlling node.

87. A telecommunication system in accordance with claim 86, wherein the switches are selected from the group that consists of STM (synchronous transmission mode) based switches, ATM (asynchronous transmission mode) based switches or IP (Internet Protocol) based switches.

88. A telecommunication system in accordance with claim 87, wherein the switch in the controlling node is an STM-based switch and the additional switch in said other node is an ATM based switch.

89. A telecommunication system in accordance with claim 75, wherein said first switch in the controlling node is a group switch.

90. A telecommunication system in accordance with claim 89, wherein a global address is a global multiple position, which is translated into a group switch multiple position for said first switch, or into a virtual multiple position for a switch in said other (kolla antecendent node, said virtual multiple position representing the local address of the switch in said other node.

91. A telecommunication system in accordance with claim 79, wherein the global addresses and their respective translations are stored in a table.

92. A telecommunication system in accordance with claim 91, wherein said table is created in the connection handler when said allocation is performed and the information stored in the table is used by the connection handler when a connection is set up.
